(19) United States
(12) Patent Application Publication
(10) Pub. No.: US 2009/0005092 A1
(43) Pub. Date: Jan. 1, 2009

(54) CONTENTION WINDOW ADAPTATION OF WIRELESS DEVICES FOR MITIGATION OF PERIODIC INTERFERENCE

(76) Inventors: Guoqing Li, Portland, OR (US); Srikathyayani Srikanteswara, Hillsboro, OR (US); Christian Maciocco, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/772,141

(22) Filed: Jun. 30, 2007

(51) Int. Cl. H04B 7/00

(52) U.S. Cl. 455/501

(57) ABSTRACT

When a wireless communications device determines that a microwave oven or other source of periodic interference is operating nearby, the device may rapidly increase the size of its contention window to reduce the number of retries that it attempts during the period of interference. Similarly, it may rapidly decrease the size of the contention window during the periods of non-interference. In some embodiments, the maximum size of the contention window derived during periods of interference may be sized to assure enough time for successful completion of at least one transmission during the next period of non-interference.

### BACKGROUND

Some communications standards (e.g., the standard IEEE 801.11 published by the Institute of Electrical and Electronic Engineers) define ‘contention windows’, i.e., periods in which devices that want to transmit will wait, after sensing an open channel, before actually transmitting. If devices try to transmit immediately after sensing that the channel is not currently in use (e.g., by sensing the absence of energy on the channel), all the devices that were waiting for a clear channel may try to transmit at the same time immediately after the channel ceases to be busy. The resulting ‘collision’ in their signals can prevent one or more of them from making a successful transmission. To reduce the chance of this happening, each device may choose a random time period, and wait until the channel has been idle for this time period (continuously or in separate sequential blocks of idle time) before trying to transmit. The action of counting down from this random number is called ‘back-off’. A ‘contention window’ defines the maximum period that the device should wait—i.e., the random values are chosen to be within the contention window. If the resulting transmission is unsuccessful, the length of the contention window can be repeatedly increased for subsequent retries, up to some maximum value, until a retry is successful. The size (duration) of the contention window can affect overall network efficiency, based on the level of network traffic, and therefore the starting size and/or maximum size may sometimes be adjusted accordingly.

However, other types of interference can affect the network efficiency by creating the same effect as collisions. For example, microwave ovens may emit radio frequency (RF) signals that interfere with the communications signals being received by the wireless communications device, creating the same effect as a collision and causing retries. But a microwave oven is not a communications device, has no back-off capability, and is not aware there is a communications problem to be dealt with, so it merely continues to transmit and interfere. In this case, the wireless communications device may continue repeating the back-off/retry process as it would for collisions, even though it has no chance of acquiring the channel while the microwave oven is emitting radiation, thus shortening its own battery life by using power to transmit the unsuccessful retries.

### BRIEF DESCRIPTION OF THE DRAWINGS

Some embodiments of the invention may be understood by referring to the following description and accompanying drawings that are used to illustrate embodiments of the invention. In the drawings;

FIG. 1 shows a network with an interfering microwave oven, according to an embodiment of the invention.

FIG. 2 shows a flow diagram of a method of adjusting the contention window when a microwave oven is determined to be operating, according to an embodiment of the invention.

FIG. 3 shows a timing diagram of transmissions during operation of an interfering microwave oven, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing or transmitting information in a form readable by a machine (e.g., a computer). For example, a machine-readable medium may include a tangible storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile wireless device” is used to describe a wireless device that may be in motion while it is communicating.

Some embodiments of the invention may monitor for signals from a microwave oven, or for other periodic interfering signals from a non-communications device (or from a communications device that does not follow the relevant communications protocols). For the purposes of this document, a periodic signal is a signal that repeats an on-off cycle with some predictable regularity. For example, when a microwave oven is operating, its radiation may turn on and off with each cycle of the AC voltage that powers the microwave. With each cycle of 60 Hz voltage, the microwave oven may radiate for about 6 milliseconds (ms) and not radiate for about 10 ms. For those microwave ovens that operate with 50 Hz voltage, the radiation/no radiation cycle may be slightly different. A wireless communications device can exploit the periodicity of the microwave signal by communicating during the non-radiating periods of the microwave, but the radiating periods can still cause problems. When an interfering device is determined to be operating, and actual interference is determined to exist (e.g., the microwave radiating period), the communications device may increase the size of its contention window more rapidly than during normal operation, thus reducing the number of attempted retries while the interference exists. Similarly, after the interference stops (e.g., the microwave non-radiating period), the communications device may reduce the size of it's contention window rapidly to return to normal operation. In some embodiments, the maximum duration of the contention window during operation of the microwave may be sized to assure a transmission can be successfully completed during the next non-radiating period.

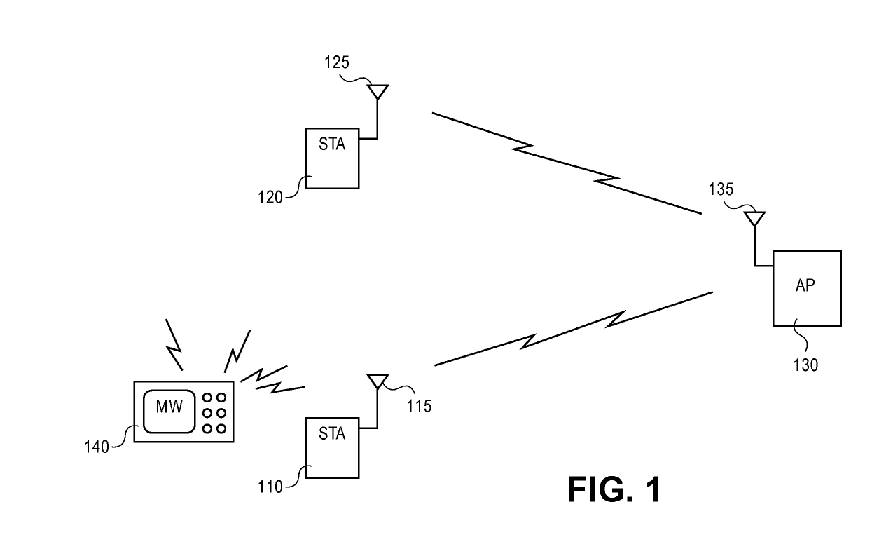

FIG. 1 shows a network with an interfering microwave oven, according to an embodiment of the invention. In the illustrated embodiment, two mobile wireless devices 110 and 120 (labeled STA, in keeping with common industry practice) may communicate wirelessly with an access point 130, through the respective antennas 115, 125, and 135. Each antenna may be of any feasible type, such as but not limited to a monopole antenna, a dipole antenna, a slot antenna, etc. In some embodiments, a single device may have two or more antennas. As shown in FIG. 1, a microwave oven 140 may be located close enough to STA 110 to interfere with signals received by STA 110 from AP 130. Although the microwave oven 140 is not a communications device and has no antenna, it may operate by generating electromagnetic radiation at a same or similar frequency as that used by the communications devices 110, 120, 130. Electromagnetic shielding my prevent any radiation escaping from the microwave oven from being strong enough to harm people standing nearby, but the radiation may still be strong enough to interfere with the signals being received by STA 110. STA 110 may make adjustments to the size of its contention window based on the interference from the microwave oven 140.

In the illustrated example, the interfering microwave oven is located near the STA 110 that is to make adjustments to its contention window based on that interference. However, placing the microwave near AP 130 (or, in another type of network, near another device that communicates directly with STA 110) may create similar problems by interfering with the other end of the communications link. In some embodiments, the operation of a microwave anywhere in the network that interferes with STA 110's communication link may trigger implementation of the embodiments described herein. Similarly, although STA 110 may monitor for microwave signals to determine when microwave 140 is operating, any other device may make this determination (e.g., STA 120) and communicate that fact directly or indirectly to STA 110. Since a microwave oven typically operates for many seconds or even several minutes at a time, any radio communications delay in forwarding the status of the microwave oven to STA 110 should have little effect on the overall operation.

Although the radiation from a microwave oven may be periodic in nature, the start and stop times of this periodic radiation may not be precise, at least not by the precision standards used by the communications devices 110, 120, 130. So STA 110 may not be able to predict exactly when the periodic radiation will start or stop. It may therefore assume that certain types of communications failures are caused by the microwave oven during those long periods of microwave operation, and are caused by other sources when a microwave oven is not determined to be operating.

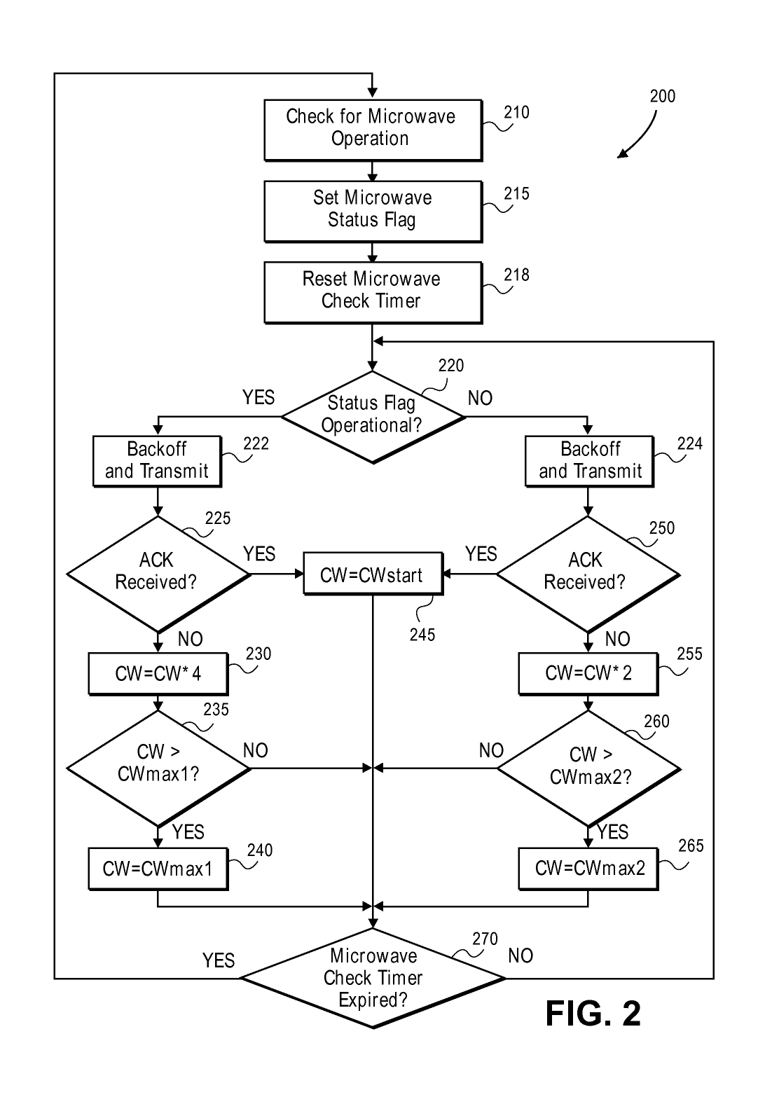

FIG. 2 shows a flow diagram of a method of adjusting the contention window when a microwave oven is determined to be operating, according to an embodiment of the invention. Flow chart 200 begins at 210, by checking to determine if a possibly interfering microwave oven is in operation. In some embodiments, checking may comprise monitoring for a predetermined time for microwave signals above a predetermined strength. At 215, a flag may be set to show the results of that check—i.e., whether a possibly interfering microwave oven is in operation or not. In some embodiments this flag may remain unchanged until the next time a check is made for microwave signals. At 218, a microwave check timer may be reset to determine how long to wait before checking for microwave operation again. Any feasible interval may be used between checking for microwave operations, e.g., one second, 50 seconds, several minutes, etc., and the timer may be set to expire after that time period. In some embodiments the interval may be adjustable, based on various conditions.

At 220, the flag may be examined to determine how to handle contention windows. If the flag indicates that a microwave oven is not in operation, then flow moves to 224, where a back-off is performed using the current contention window, and then one or more frames are transmitted after that back-off period. If an acknowledgment (ACK) to that transmission is received at 250 (indicating that the transmission was successfully received by the destination device), then the contention window CW may be set to its default value of CWstart at 245, and the microwave check timer examined at 270 to determine if it is time to monitor for microwave operation again.

However, if an ACK is not received within a designated timeout period at 250, it may be assumed that the communications failure is due to collisions, and the contention window may be increased in the convention manner. The example shows the contention window being approximately doubled in size at 255. Note: some algorithms for increasing the contention window will add or subtract 1 from the doubled size, so that a contention window counter will need the minimum number of bits for that value, but this approximation is sufficient to illustrate the process here. At 260 and 265, the new size of the contention window may be held to a predetermined maximum value of CWmax2. At 270, the microwave check timer may be examined to determine if it is time to check for an operational microwave oven again.

Returning to decision block 220, if the flag indicates that a microwave oven is operational, then flow moves to 222, where a back-off is performed using the current contention window, and then one or more frames are transmitted after that back-off period. If an ACK to that transmission is received at 225 (indicating that the transmission was successfully received by the destination device), then the contention window CW may be set to its default value of CWstart at 245, and the microwave check timer examined at 270 to determine if it is time to monitor for microwave operation again.

However, if an ACK is not received within a designated timeout period at 225, it may be assumed that the communications failure was due to interference from a microwave oven, and the contention window may be increased at a more rapid rate than at 255. In the illustrated example, the contention window may be approximately quadrupled in size at 230 (as contrasted with the approximate doubling in size at 255). Operations 235 and 240 may be used to assure that the new contention window does not exceed a predetermined maximum value of CWmax1. After the contention window has been increased, the microwave check timer may be examined to determine if it is time to check for microwave operation again.

Regardless of what path was followed to reach decision block 270, if the microwave check timer has not expired, then control may move to 220, where the status of the flag is examined and a new back-off/transmit process is performed, using the current value of the contention window. However, if the microwave check timer has expired, then control may move to 210 to check for microwave operation again.

Through the operations of flow diagram 200, a wireless communications device may increase the size of its contention window at one rate if collisions are assumed be the cause of a communications failure, and at a faster rate if interference from a microwave oven is assumed to be the cause of the communications failure. In the example, the rate of increase due to microwave interference is approximately double the rate of increase due to collisions within the network, but other embodiments may use a different rate of increase (e.g., 3 times, 8 times, etc.). Further, in some embodiments the increase might not be strictly exponential, as may be the case if multiple passes through the flow diagram are made. For example, in some embodiments the first increase from CWstart may be CW*8, while the next increase may be CW*3, the next CW*2, etc. In addition, CWmax1 may be different than CWmax2. Depending on the specifics of network operation and the cycle times of the microwave oven, CWmax1 may be more or less than CWmax2 to achieve good results for each case. Factors that may affect CWmax1 are discussed later in more detail.

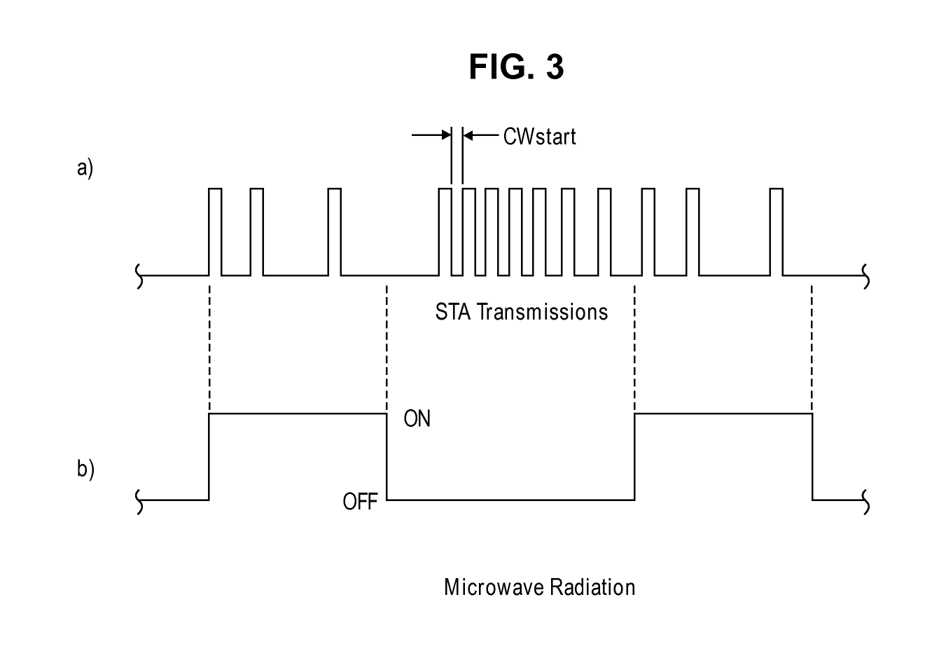

FIG. 3 shows a timing diagram of transmissions during operation of an interfering microwave oven, according to an embodiment of the invention. Diagram b) shows approximately one and a half cycles of radiation from the microwave (a time period of approximately 25-30 ms), with ON corresponding to the times when the microwave is emitting radiation, and OFF corresponding to the times when the microwave is operating but is not emitting radiation. The microwave is considered to be ‘in operation’ during the entire time. Diagram a) shows transmissions from the STA that is adjusting its contention window, with a high signal indicating an actual transmission, and a low showing the time between transmissions, including the contention window. When the microwave is not emitting radiation, most of the time between transmissions are shown to be dominated by the baseline contention window CWstart, indicating that most transmissions are successful (the ACK is received). But during the times when the microwave is emitting radiation, the ACK is usually not received, and the time between transmissions rapidly increases, indicating a rapidly increasing contention window. Note: FIG. 3 is meant to illustrate the concept, but is not drawn to scale, as the relative time periods involved might be too small to accurately see in the drawing.

As previously described, CWmax1 is the maximum contention window allowed during periods of possible microwave interference. This value may be affected by the fact that the maximum backoff allowed by the contention window (i.e., a backoff equal to the contention window) may start during a period of interfering radiation, but extend into a period of non-interference. If the contention window starts just before the period of interference ends, most of the contention window will take place during the period of non-interference, when a large contention window is no longer beneficial. It may be desirable to assure that the wireless communications device will have time to successfully complete at least one transmission before the period of non-interference expires, and this consideration may affect the size of CWmax1. For example, to successfully complete a transmission, time may be allowed to accommodate the following:

1) DIFS (distributed interframe space, a mandatory time period in a communications sequence that allows for timing differences between different network devices, and for those devices to switch between transmit and receive modes)

2) the contention window (which can be no greater than CWmax1)

3) time to transmit (packet size/transmission rate) The transmission rate for the next transmission may not be known at the time the contention window is calculated, so the slowest rate may need to be assumed when predicting this value.

4) SIFS (short interframe space, another mandatory time period similar to DIFS)

5) ACK response time (including turnaround time for the AP). The actual time for the AP to receive the transmission and respond with an ACK may not be known in advance, so an estimate may need to be made based on past performance.

If the sum of those parameters exceeds the non-radiation period of the microwave oven (e.g., 10 ms), then there is a chance that the transmission sequence will not be successfully completed before the next radiation period begins interfering with it, and the transmission will therefore have to be retried. To avoid this, CWmax1 may be determined by the sum of those parameters, assuming worst case estimates of some of the parameters. In some operations, a larger value of CWmax1 may be obtained by shortening the packet size and/or by increasing the transmission rate, when those alternatives are feasible. Alternatively, CWmax1 may be permitted to be somewhat larger than the sum of those parameters, because the actual delay before transmitting is usually less than the contention window (remember, the actual backoff time is based on a random number, and is chosen to be less than or equal to the contention window size), and because the turnaround time of the AP may be only an estimate. Choosing a larger value for CWmax1 in this manner may therefore be feasible in some operations. Although some transmissions may fail and have to be retried, others may succeed. Making this tradeoff may depend on many possible considerations, which are beyond the scope of this document.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising:
a first wireless communications device having a radio to transmit and receive on a channel that is subject to periodic radio interference from a non-communications device, the first wireless communications device to:
determine if the non-communications device is in operation;
transmit to a second wireless communications device; and
increase a size of a contention window if an acknowledgement to the transmission is not received from the second wireless communications device, wherein the increase is by a first amount if the non-communications device is in operation and the increase is by a second amount less than the first amount if the non-communications device is not in operation.

2. The apparatus of claim 1, wherein the non-communications device comprises a microwave oven.

3. The apparatus of claim 1, wherein the first wireless communications device is to retry the transmission if the acknowledgment is not received, using the increased contention window to limit a maximum time to wait before transmitting.

4. The apparatus of claim 1, wherein the first amount is substantially twice the second amount.

5. The apparatus of claim 1, wherein the contention window is limited to a first maximum value if the non-communications device is determined to be in operation, and the contention window is limited to a second maximum value if the non-communication device is determined to not be in operation.

6. The apparatus of claim 5, wherein the first maximum value is to be determined by parameters that include a predicted time to transmit a subsequent transmission and an estimated response time for the acknowledgement to the subsequent transmission.

7. The apparatus of claim 6, wherein the first maximum value is to be determined so that worst case values for the parameters will permit a successful completion of the subsequent transmission before a subsequent period of interference begins.

8. The apparatus of claim 1, wherein the first wireless communication device comprises multiple antennas to wirelessly communicate on the channel.

9. A method, comprising:
transmitting a packet from a first wireless communications device to a second wireless communications device on a channel that is subject to periodic radio interference from a non-communications device;
determining if the non-communications device is in operation; and
increasing a size of a contention window if an acknowledgement to said transmitting is not received, wherein the increase is by a first amount if the non-communications device is in operation and the increase is by a second amount less than the first amount if the non-communications device is not in operation.

10. The method of claim 9, wherein the non-communications device comprises a microwave oven.

11. The method of claim 9, further comprising retransmitting the packet if the acknowledgment is not received, using the increased contention window to determine when to retransmit.

12. The method of claim 9, wherein the first amount is substantially twice the second amount.

13. The method of claim 9, wherein the contention window is limited to a first maximum value if the non-communications device is determined to be in operation, and the contention window is limited to a second maximum value if the non-communications device is determined to not be in operation.

14. The method of claim 13, further comprising determining the first maximum value by using parameters that include a predicted time to transmit a subsequent transmission and an estimated response time for the acknowledgement to the subsequent submission.

15. The method of claim 14, further comprising determining the first maximum value so that worst case values for the parameters will permit a successful completion of the retransmission before a subsequent period of interference begins.

16. An article comprising
a tangible machine-readable medium that contains instructions, which when executed by one or more processors result in performing operations comprising:
transmitting a packet from a first communications device to a second communications device on a wireless channel that is subject to periodic radio interference from a non-communications device;
determining if the non-communications device is in operation; and
increasing a size of a contention window if an acknowledgement to said transmitting is not received, wherein the increase is by a first amount if the non-communications device is in operation and the increase is by a second amount less than the first amount if the non-communications device is not in operation.

17. The article of claim 16, wherein the operations comprise assuming the interference is from a microwave oven.

18. The article of claim 16, wherein the operations further comprise retransmitting the packet if the acknowledgment is not received, using the increased contention window to determine when to retransmit.

19. The article of claim 16, wherein the first amount is substantially twice the second amount.

20. The article of claim 16, wherein the contention window is limited to a first maximum value if the non-communications device is determined to be in operation, and the contention window is limited to a second maximum value different than the first maximum value if the non-communications device is determined to not be in operation.

21. The article of claim 20, wherein the operations further comprise determining the first maximum value by using parameters that include a predicted time to transmit a subsequent transmission and an estimated response time for the acknowledgement to the subsequent transmission.

22. The article of claim 21, wherein the operations further comprise determining the first maximum value so that worst case values for the parameters will permit a successful completion of the retransmission before a subsequent period of interference begins.
